(19) United States
(12) Patent Application Publication
(10) Pub. No.: US 2003/0190444 A1
(43) Pub. Date: Oct. 9, 2003

(54) Tube for conveying hydraulic fluid

(76) Inventors: Georg Stoppelmann, Bonaduz (CH); Michael Hoffmann, Bonaduz (CH)

Correspondence Address: John B. Hardaway, III, Nexsen Pruet Jacobs Pollard, LLC, 201 West McBee Avenue, Suite 400, Greenville, SC, 29601, US

(21) Appl. No.: 10/357,104

(22) Filed: Feb. 3, 2003

(30) Foreign Application Priority Data
Apr. 2, 2002 (DE) 102 04 395.7

(51) Int. Cl. B32B 1/08

(52) U.S. Cl. 428/36.91; 428/36.9

(57) ABSTRACT

The invention relates to a hydraulic line for motor vehicles based on thermoplastic polymers comprising at least one layer comprising a molding compound based on polyamide, wherein the polyamide molding compound contains nano-scale fillers in a quantity of 0.5 to 50% by weight, in particular in a quantity of 1 to 30% by weight per 100 parts by weight of the polymer matrix.

### FIELD OF THE INVENTION

This invention relates to thermoplastic polyamide polymer reinforced with nano-scale fillers useful for flexible hoses in hydraulic pluming line. The hoses may be in one or more layers and are preferable co-polymers. The fillers are oxides or oxide hydrates of metals or silicon which are co-extruded with the polyamides.

### BACKGROUND AND PRIOR ART

The present invention therefore relates to flexible plastic tubes or lines, whose walls are comprised of one or a plurality layers.

The plastic tubing or lines used in motor vehicle construction must generally fulfill a number of requirements. In the case of a hydraulic clutch, its function can be described as follows. The individual components of hydraulic systems are: a reservoir containing hydraulic fluid, a clutch pedal, a clevis pin, a master cylinder, a hydraulic line, a slave cylinder and a releasing means, wherein this listing of components is solely exemplary and additional components can be included such as solenoid valves, reservoirs, return pumps, depending on the manufacturer. After actuating the clutch pedal, pressure is built up in the system by way of the master cylinder and is transferred over the hydraulic line to the slave cylinder. Here, hydraulic oil is used as the transfer medium, which is both in the line and in the hydraulic oil storage reservoir. The force is transferred mechanically from the slave cylinder to the releasing means typically a fork and throw-out bearing whereby the clutch is released and the transmission is disconnected from the motor.

To assure proper functioning of the clutch the following prerequisites must be fulfilled by the hydraulic line: it must have sufficient bursting strength up to 130° C., as little volume change as possible over the temperature range of from −40° C. to 130° C. and less than 2-3% water permeation into the hydraulic fluid from the outside, no decomposition reaction with the hydraulic fluid, high temperature stability, and low temperature impact strength to −40° C. A particular drawback to proper functioning of a hydraulic clutch is excessive water absorption by the fluid, which can result in foaming of the hydraulic medium at temperatures above 100° C. and excessive volume change in the line, whereby the clutch travel is extended.

Until now, hydraulic lines have conventionally been configured as galvanized steel lines, which are fastened to the walls, in particular the cargo space walls, of trucks by means of tubing cleats or as clutch lines used in passenger vehicle applications. Metal tubing has many of the aforesaid desirable properties. However, manufacturing said metal tubing is very costly. Furthermore, with tubing made of steel there is the drawback, for example, of its weight and unsatisfactory resistance to corrosion. Fast installation is made more difficult due to its high rigidity.

The hydraulic lines or tubing under discussion are generally situated in an aggressive environment, in which said tubing is exposed to chemical attack by mineral salt solutions and the fluid being conducted and must, as already mentioned, also withstand high pressures over a wide range of temperatures from −40° C. to +130° C., for example. The media used in the hydraulic lines or tubing for force transmission must fulfill a safety function in hydraulic brakes. The brake fluids are therefore the subject of many international standards such as SAE J 1703, FMVSS 116, ISO 4925, for example. The features described in FMVSS 116 have attained the status of legislation in the United States and are authoritative worldwide. The Department of Transportation (DOT) has defined various quality categories for the most important properties.

TABLE
Brake Fluids

| | |
|---|---|
| Testing According to | FMVSS 116 |

| Requirements/Status | DOT 3 | DOT 4 |
|---|---|---|
| Dry Boiling Point in ° C. | 205 | 230 |
| (minimum) | | |
| Wet Boiling Point in ° C. | 140 | 155 |
| (minimum) | | |
| Low Temperature Viscosity at | 1500 | 1800 |
| −40° C. in mm³/s | | |

The wet boiling point shown in the above table is the equilibrium boiling point of the brake fluid, after it has taken up water under defined conditions (approximately 3.5%).

Primarily, in the case of hygroscopic fluids based on glycols, this results in a dramatic decrease in the boiling point. Investigation of the wet boiling point should describe the properties of the brake fluid used, which can absorb water mainly by diffusion through the brake hoses. It is essentially this effect that makes it necessary to change the brake fluid in a motor vehicle after one to two years. The temperature dependency of the viscosity must be as low as possible in order to allow safe brake function over the extended range of use from −40° C. to 130° C. The particular type of hydraulic or brake fluid requires matching the thermoplastics used in the brake system. A minimal expansion of the thermoplastics is desirable. Under no circumstances should it exceed approximately 10%, since the strength of the components will be impaired.

Glycol ether fluids are the most frequently used hydraulic and brake fluids in these applications; generally, it concerns monoethers of low molecular weight polyethylene glycols. Using these components, hydraulic and brake fluids can be manufactured that comply with the requirements of DOT 3. The drawback is that they absorb water relatively quickly because of their hygroscopic properties and the boiling point drops accordingly.

If the free hydroxyl groups of these glycoethers are partially or extensively esterified using boric acid, components for manufacturing substantially better DOT 4 fluids are created.

Because of their reactivity with water, they chemically block it. Thus the boiling point of the DOT 3 fluids clearly drop more slowly and service live increases accordingly.

In order to provide sufficient flexibility for mounting hydraulic lines or tubing and to allow adaptation to the movements of the motor and transmission and suspension, flexible elements are used for the hydraulic line.

One possibility is to use a corrugated metal hose, as described in DE-A-199 51 947, which has the drawback of higher costs. Other solutions are lines comprised of elastomers, which comprise one or a plurality of layers of reinforcing filament yarn that can be made of polyester, polyamide or glass fibers or metal wires in order to increase the burst pressure. Examples of this can be found in DE-A-198 57 515 or EP 0 740 098 A1. This manufacturing process is expensive in terms of equipment, there are no recycling possibilities and the majority of elastomers have a high water permeation rate.

In order to provide a simpler manufacturing method, hydraulic lines based on thermoplastics were developed, whereby standard polyamides are used that do not require modifications other than the heat and UV stabilizers, dyes and processing facilitators (see DIN 73378: Single-layer Polyamide Tubing for Motor Vehicles). These single lines have the drawback that on the one hand they allow high water permeation from the outside towards the inside and on the other hand they exhibit high volume alteration in the temperature range of −40 to 120° C. Such thermoplastic tubing can also be provided with reinforcement elements (see U.S. Pat. No. 2,614,058) for reducing volume alterations.

In order to eliminate the drawbacks of the single tubing, therefore, multilayered systems have been developed. These can be combinations of elastomers and thermoplastics that are provided with additional reinforcement. For example, U.S. Pat. No. 4,617,213 describes a line having the following structure: a layer of polychloroprene rubber is applied on a inner layer of polyamide 11, which is bonded with the inner layer by an isocyanate bonding agent. A reinforcing fiber is applied to this rubber layer which is enveloped externally by a further polychloroprene layer. Manufacturing this layered structure is also very costly such that multilayer purely thermoplastic solutions have been developed.

DE-8008440 U1 describes bilayered tubing comprised of PA 6 or PA66 (inner) and a PA11 or PA12 (outer) layer. These have the particular advantage of a higher burst pressure at 120° C. than solely PA11 or PA12 simple tubing. But this construction has the weakness that because of inadequate compatibility of the outer and the inner materials, the layers bond poorly with each other. Also in DE-A-195 04 615, which describes tubing of at least three layers, having a middle layer containing an amount up to 50% of co-polymers, the bonding problem is solved only in part.

### BRIEF DESCRIPTIONS OF THE INVENTION

The present invention relates to novel lines based on polyamides for transporting hydraulic media such as, for example, hydraulic fluids or oils, which are used for transmission of forces in brakes and clutches, for example. The hydraulic lines according to the invention are characterized by an improved barrier effect, particularly relative to permeation of gases and liquids like water. The hydraulic lines according to the invention can be made of merely a polyamide layer or can comprise a multilayer structure. In the case of a multilayer structure, the additional layers, for example, can be comprised of polyolefins such as, for example, polyethylenes, polypropylenes or propylene copolymers such as, for example, co-polymers comprised of propylene and acrylic acid or methacrylic acid or ethylene and vinyl alcohol (called EVAL or EVOH).

Monolayer plastic tubes made of polyamide have long been prior art and are used in many applications such as for brake, hydraulic, fuel, cooling, pneumatic lines, for example (compare DIN 73378: “Polyamide Tubing for Motor Vehicles”).

Multilayer reinforced lines are described in DE-A-294 56 37 and DE-A-199 39 689 that have adequate bonding only if the outer and inner layers are identical or are miscible in the thermodynamic sense, which applies to only a very few polymer pairs.

Therefore, a first object of the present invention is to provide a constructive solution for a hydraulic line, which fulfills the following requirements: adequate bursting strength up to 130° C., as little volume change as possible in the temperature range of −40 to 130° C., water permeation from the outside into the hydraulic oil of less than 2-3%, no breakdown reactions with the hydraulic oil, high temperature stability and low temperature impact strength to −40° C.

It was unexpectedly found that these multiple requirements are fulfilled according to the invention by molding compounds that comprise fillers on the nano-scale.

Therefore, the invention relates to a hydraulic line for vehicles based on thermoplastic polymers, containing at least one layer comprised of a molding compound based on polyamide, wherein the polyamide molding compound comprises nano-scale fillers in a quantity of from 0.5 to 50% by weight, in particular in a quantity of from 1 to 30% by weight per 100 parts by weight of the polymer matrix weight.

The invention further relates to a multilayered hydraulic line comprising at least an inner layer comprised of a molding compound based on polyamide molding compounds filled with nano-scale fillers, a polyolefin intermediate layer or an intermediate layer comprised of a molding compound based on ethylene/vinyl alcohol co-polymers, and a polyamide outer layer.

### DETAILED DESCRIPTION OF THE INVENTION

### BRIEF DESCRIPTION OF THE DRAWINGS

FIG. 1 is the structure of a silsequioxane.

### DETAILED DESCRIPTION OF THE INVENTION

The nano-scale fillers used according to the invention are chosen from the group comprising the metal or semi-metal oxides or oxide hydrates. In particular, the nano-scale fillers are chosen from the group comprised of oxides and oxide hydrates of an element chosen from the group comprising boron, aluminum, gallium, indium, silicon, germanium, tin, titanium, zirconium, zinc, yttrium and/or iron.

In one particular embodiment of the invention the nano-scale fillers are either silicon dioxide or silicon dioxide hydrates. In one embodiment, the nano-scale fillers are present in the polyamide molding compound as a uniformly dispersed, layered material. Prior to being incorporated into the matrix they have a layer thickness of 0.7 to 1.2 mm and an interlayer separation of the mineral layers of up to 5 nm.

In the polyamide (PA) systems, in which the filler particle dimensions are in the nanometer range, there are the following effects: the thermal expansion coefficient is clearly reduced compared with the unfilled matrix polymers particularly in the processing direction, the finely distributed particles reduce the permeation of gases and liquids like water without reducing viscosity as in classically filled systems (composites). By virtue of the molecular reinforcement, mechanical properties are improved even at elevated temperatures.

In order to specifically reduce water absorption by the hydraulic fuel, monolayer tubing made of so-called nano-composite materials or multilayer tubing can be used, whereby in the latter case at least one layer must comprise at least one layer of nano-composite material.

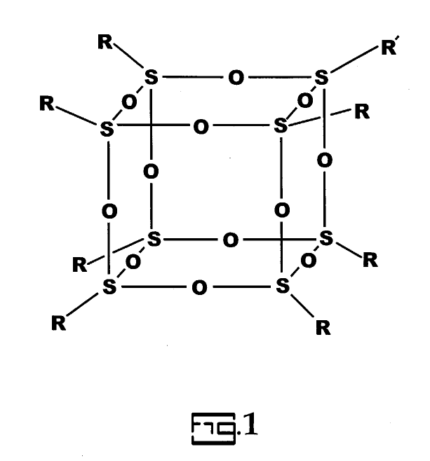

Such materials, that can be added at any stage in manufacturing the polymer, whereby they can be finely distributed in the nanometer range, are suitable as fillers for manufacturing nano composites. These are preferred minerals according to the invention that already have a layered structure such as layered silicates, double hydroxides such as hydrotalcite or even graphite. Nano-fillers base on silicones, silica or silsesquioxanes (see FIG. 1) are also suitable.

In the context of the invention, layered silicates are understood to be 1:1 and 2:1 layered silicates. In these systems, layers of SiO₄ tetrahedrons are regularly linked together with layers comprised of M (O,OH)₆₋ octahedrons, wherein M represents metal ions like Al, Mg, Fe. In the 1:1 layered silicates one tetrahedron is connected with one octahedron layer respectively. Examples of this are kaolin and serpentine minerals.

In the case of the 2:1 layered silicates two tetrahedrons are combined with one octahedron layer respectively. If all octahedron sites are not available with cations of the required charge to compensate for the negative charge of the SiO₄ tetrahedrons and the hydroxide ions, charged layers occur. This negative charge is balanced by the insertion of monovalent cations like potassium, sodium or lithium or divalent cations such as calcium into the space between the layers. Examples of 2:1 layered silicates are talc, mica, vermiculites, illites and smectites, wherein the smectites to which belong montmorillonite, and which easily swell with water due to their layer charge. Furthermore, the cations are easily accessible for exchange processes.

The swellable layered silicates are characterized by their ion exchange capacity CEC (meq/g) and their layer separation d_{L}. Typical values for CEC are between 0.7 to 0.8 meq/g. The layer separation in a dry, untreated montmorillonite is 1 nm and increases up to 5 nm with swelling with water or coating with organic compounds.

Examples of cations that can be used for exchange reactions are ammonium salts of primary amines having at least 6 carbon atoms such as hexane amine, decane amine, dodecane amine, hydrated C₁₈ tall oil amines or even quaternary ammonium compounds such as ammonium salts of α-, ω-amino acids with at least 6 carbon atoms. Other activation reagents containing nitrogen are the triazine-based compounds. Such compounds are described, for example, in EP-A-1 074 581; therefore, particular reference is made to that document.

Chlorides, sulfates or even phosphates are suitable anions. Along with the ammonium salts, sulfonium or phosphonium salts such as tetraphenyl or tetrabutyl phosphonium halides, for example, can be used.

Since polymers and minerals commonly have very different surface tensions, coupling agents can be used according to the invention in addition for treating the minerals for cation exchange. When this is done, titanates or even silanes such as y-amino propyl triethoxy silane are appropriate.

As polyamides (PA) for the molding compounds according to the invention, from which polymerizates of aliphatic C₆-C₁₂ lactams or ω-amino carboxylic acids with 4 to 44 carbon atoms, preferably 4 to 18 carbon atoms, or polycondensates can be used advantageously for manufacturing the hydraulic lines according to the invention, which can be obtained by polycondensation of at least one diamine from the group comprising the aliphatic diamines with 4 to 12 C-atoms, the cyclo-aliphatic diamines with 7 to 22 C-atoms and the aromatic diamines with 6 to 22 C-atoms in combination with at least one dicarboxylic acid from the group comprising aliphatic dicarboxylic acids with 4 to 12 catoms, cycloaliphatic dicarboxylic acids with 8 to 24 C-atoms and aromatic dicarboxylic acids with 8 to 20 C-atoms. The ω-amino carboxylic acids or the lactams are chosen from the group comprising ε-aminocapronic acid, 11-aminoundecanoic acid, 12-aminododecanoic acid, ε-caprolactam, enanthlactam, ω-laurin lactam. Furthermore, it is also possible according to the invention to use blends of the aforesaid polymerizates or polycondensates, respectively. Appropriate diamines according to the invention, which are combined with a dicarboxylic acid, are 2,2,4- or 2,4,4-trimethyl hexamethylene diamine, 1,3- or 1,4-bis (aminomethyl) cyclohexane, bis (p-amino cyclohexyl) methane, m- or p-xylylene diamine, ethyl diamine, 1,4 diamino butane, 1,6-diamino hexane, 1,10-diamino decane, 1,12-diamino dodecane, cyclohexyl dimethylene amine.

Examples of dicarboxylic acids are succinic acid, glutaric acid, adipic acid, pimelic acid, suberic acid, azelaic acid, and sebacic acid, dodecanedioic acid, 1,6-cyclohexane dicarboxylic acid, terephthalic acid, isophthalic acid and naphthalene dicarboxylic acid.

Concrete examples of the (co-)polyamides for the hydraulic line according to the invention are, therefore, such homo- or co-polyamides from the group comprising PA6, PA66, PAll, PA46, PA12, PA1212, PA1012, PA610, PA612, PA69, PA6T, PA6I, PA10T, PA12T, PA121, mixtures thereof or co-polymers based on these polyamides, wherein PA11, PA12, PA1212, PA10T, PA12T, PA12T/12, PA1OT/12, PA12T/106, PAlOT/106 are preferred. Preferred, according to the invention, are also co-polymers based on the aforementioned polyamides such as, for example, PA12T/12, PA10T/12, PA12T/106 and PA10T/106. Furthermore, PA6/66, PA6/612, PA6/66/610, PA6/66/12, PA6/6T and PA6/6I can also be used according to the invention.

The present invention relates also to a hydraulic line comprising at least one inner layer comprised of a molding compound based on polyamide molding compounds filled with nanoscale fillers, which have already been described above, a polyolefin interlayer or an interlayer comprised of a molding compound based on ethylene/vinyl alcohol co-polymers and a polyamide outer layer. As polyamides for the inner and outer layers those from the group comprising polyamide 6, polyamide 11, polyamide 46, polyamide 12, polyamide 1212, polyamide 1012, polyamide 610, polyamide 612, polyamide 69, polyamide lOT, polyamide 12T, polyamide 121, mixtures thereof or co-polymers based on these polyamides, wherein polyamide 11, polyamide 12, polyamide 1212, polyamide 10T, polyamide 12T, polyamide 12T/12, polyamide 10/12, polyamide 12T/106, polyamide 10T/106 are preferred, or from the group comprising polyamide 6/66, polyamide 6/612, polyamide 6/66/610, polyamide 6/66/12, polyamide 6/6T, polyamide 6/6I can be used.

The polyolefin of the interlayer can be either polypropylene or a mixture of ethylene/α-olefin co-polymer and ethylene/alkyl(meth) acrylate/maleic anhydride or glycidyl(meth)acrylate co-polymer.

Preferably the polyamide for the inner layer will be chosen from the group comprising polyamide 12, polyamide 6, polyamide 610, polyamide 612. The polyolefin interlayer is comprised of polypropylene. According to this embodiment the outer layer can be comprised of polyamide 12.

In a further embodiment the inner layer can be comprised of a molding compound based on polyamide 6, polyamide 46, polyamide 66, polyamide 69, polyamide 610 or polyamide 612 followed by a layer of a molding compound based on ethylene vinyl alcohol copolymers, if required, with a bonding layer disposed therebetween and an outer layer comprised of polyamide 12. Such coupling agents are well-known to those skilled in the art. In this context, reference is made by way of example to this applicant's DE 101 10 964.4.

Still other, conventional polymers, well-known to those skilled in the art, can be added in amounts up to 30% by weight to these (co-)polyamides for particular purposes. The (co-) polymers used can include those common additives impact strength modifiers such as EPM and EPDM, elastomers or rubber reinforces or fillers, UV stabilizers, antioxidants, pigments, dyes, nucleating agents, crystallization accelerators, crystallization inhibitors, fluidizer, lubricants, defoaming agents, flame retardants, and agents improving electrical conductivity, all of which may be blended into the polymers. EPM and EPDM are added to the polyamide molding compounds preferably in quantities of 5 to 20% by weight, in particular in quantities of 5 to 10% by weight.

A hydraulic line according to the present invention can be manufactured in one or a plurality of stages by injection molding, co-extrusion, extrusion-blow-molding, pressing or sheating process.

The following examples explain the present invention more fully, but non-limitingly. Materials used: Polyamide 12: Highlyviscous PA12 with the following properties

| | | | MVI, | |
|---|---|---|---|---|
| | | Relative | 275° C., 5 | Ash |
| | Fusion | Viscosity (m- | kg (cm³/10 | Content |
| | Point (° C.) | cresol) | min) | % |
| Standard PA12 | 178 | 2.25 | 20 | 0.1 |
| PA12 nano-com- | 178 | 2.18 | 13 | 4 |
| posite | | | | |

Layered Silicate:

Na-montmorillonite treated with 30 meq/110 g mineral methyl tall oil bis-2-hydroxyethyl ammonium chloride d_{L}: 1.85 nm

The nanocomposite molding compounds were manufactured on a 30 mm Werner & Pfleiderer ZSK 25 double-screw extruder at temperatures between 240 and 280° C. Accordingly, the polymer was added to the charger of the extruder and the mineral added in the charger zone of the extruder and/or to the melt. Addition of the modified layered silicate was 6% by weight.

Investigation of the molding compounds according to the invention and not according to the invention was done according to the following specifications:

| | |
|---|---|
| MVI: | (Melt Volume Index) at 275° C./5 kg |
| | according to ISO 1133 |
| SZ: | Impact strength according to ISO |
| | 20 179/l1U |
| KSZ: | Low-temperature impact strength |
| | according to ISO 179/leA |
| Yield stress: | ISO 527 |
| Stretch-to-break: | ISO 527 |
| Tensile mod. of elasticity: | ISO 527 |

| | | | PA12 | |
|---|---|---|---|---|
| | | | nano-composite | Standard PA12 |
| Tensile modulus of | dr. | Mpa | 2500 | 1500 |
| elasticity | | | | |
| Tensile modulus of | cond. | MPa | 1900 | 1100 |
| elasticity | | | | |
| Yield stress | dr. | Mpa | 55 | 45 |
| Yield stress | cond. | Mpa | 50 | 40 |
| Elongation to rupture | dr. | % | 110 | 200 |
| Elongation to rupture | cond. | % | 170 | 200 |
| Impact strength, | cond. | kJ/m² | N.E. | N.E. |
| 23° C. | | | | |
| Impact strength, | cond. | kJ/m² | N.E. | N.E. |
| −30° C. | | | | |
| Notch impact strength, | cond. | kJ/m² | 6 | 10 |
| 23° C. | | | | |
| Notch impact strength, | cond. | kJ/m² | 7 | 7 |
| −30° C. | | | | |
| HDT A | | ° C. | 60 | 45 |
| HDT B | | ° C. | 130 | 115 |

For determining water absorption, monolayer tubing with dimensions of 8×2.25 mm was manufactured on a Nokia tube extrusion machine. The tubing was then filled with anhydrous type DOT3 or DOT4 hydraulic fluid and sealed. Then the tubing was placed in a water bath at 70° C. for 70 hours. Thereafter, the water content of the hydraulic fluid was determined. The following table shows that in the tubing according to the invention, a clearly lower water absorption of the hydraulic oil occurs.

| | Water Absorption | Water Absorption |
|---|---|---|
| | DOT3 | DOT4 |
| Standard PA12 | 2.7 | 3.2 |
| PA12 nano-composite | 1.4 | 1.8 |

Although the invention has been described with reference to particular embodiments, it will be apparent to one of ordinary skill in the art that modifications of the described embodiments may be made without departing from the spirit and scope of the invention.

1. A hydraulic line for motor vehicles based on thermoplastic polymers comprising at least one layer comprised of molding polyamide compound wherein the polyamide molding compound contains nano-scale fillers in a quantity of 0.5 to 50% by weight, per 100 parts by weight of polymer compound.

2. The hydraulic line according to claim 1, wherein the nano-scale fillers are selected from the group consisting of the oxides and/or oxide hydrates of metals or semi-metals.

3. The hydraulic line according to claim 2, wherein the nano-scale fillers are selected from the group consisting of the oxides and oxide hydrates of an element selected from the group consisting of boron, aluminum, magnesium, gallium, indium, silicon, germanium, tin, titanium, zirconium, zinc, yttrium and iron.

4. The hydraulic line according to claim 3, wherein the nano-scale fillers are chosen from silicon dioxide and silicon dioxide hydrates.

5. The hydraulic line according to claim 4, wherein the polyamide molding compound in said polyamide comprises as the filler a uniformly dispersed, layered mineral, which has a layer thickness of 0.7 to 1.2 nm and an interlayer separation of mineral layers of up to 5 nm prior to incorporation into the polyamide matrix.

6. The hydraulic line according to claim 5, wherein the mineral uniformly dispersed in the polymer matrix has a cation exchange capacity of 0.5 to 2 meq/g, preferably from 0.7 to 0.8 meq/g, of mineral.

7. The hydraulic line according to claim 6, wherein the mineral is treated with an activation or modification agent from the group comprising triazines, the ammonium salts of primary amines with at least 6 carbon atoms, or quaternary ammonium compounds, ammonium salts of α-, ω-amino acids with at least 6 carbon atoms, and sulfonium and phosphonium salts.

8. The hydraulic line according to claim 7, wherein the nano-scale fillers are layered silicates selected from the group consisting of montmorillonite, saponite, beidellite, nontronite, hectorite, stevensite, vermiculite, illite, pyrosite, of the group comprising kaolin and serpentine minerals, double hydroxides, and graphite.

9. The hydraulic line according to claim 8, wherein the mineral is treated with a coupling agents and is contained up to 2% by weight in the polyamide molding compound.

10. The hydraulic line according to claim 1, wherein the polyamides are polymers comprised of aliphatic C₆-C₁₂ lactams or ω-amino carboxylic acids with 4 to 44 carbon atoms, preferably 4 to 18 carbon atoms, or copolymers, obtainable by polycondensation of at least one diamine of the group comprising the aliphatic diamines with 4 to 12 C-atoms, the cyclo-aliphatic diamines with 7 to 22 C-atoms and the aromatic diamines with 6 to 22 C-atoms in combination with at least one dicarboxylic acid from the group comprising aliphatic dicarboxylic acids with 4 to 12 C-atoms, cyclo-aliphatic dicarboxylic acid with 8 to 24 C-atoms and aromatic dicarboxylic acids with 8 to 20 C-atoms, wherein also blends of the aforesaid polymers and/or polycondensates are suitable.

11. The hydraulic line according to claim 10, wherein the ω-amino carboxylic acids and the lactams are chosen from the group comprising ε-amino capronic acid, 11-amino undecanoic acid, 12-amino dodecanoic acid, ε-caprolactam, enanthlactam, ω-laurin lactam.

12. The hydraulic line according to claim 10, wherein the diamines are chosen from the group comprising 2,2,4- or 2,4,4-trimethyl hexamethylene diamine, 1,3- or 1,4-bis (aminomethyl) cyclohexane, bis (p-aminocyclohexyl) methane, m- or p-xylylene diamine, ethyl diamine, 1,4-diamino butane, 1,6-diamino hexane, 1,10-diamino decane, 1,12-diamino dodecane, cyclohexyl dimethylene amine, and the dicarboxylic acids are chosen from the group comprising succinic acid, glutaric acid, adipic acid, suberic acid, pimelic acid, azelaic acid, sebacic acid, docecandioic acid, 1,6-cyclohexane dicarboxylic acid, terephthalic acid, isophthalic acid, naphthalene dicarboxylic acid.

13. The hydraulic line according to claim 1 comprising further polymers in quantities up to 30% by weight selected from the group consisting of impact strength modifiers, elastomers rubbers, reinforcers and fillers, the UV stabilizers, the antioxidants, pigments, dyes, nucleating agents, crystallization accelerators, crystallization inhibitors, fluidizers, lubricants, defoaming agents, flame retardants and agents improving electrical conductivity are added to the polyamides.

14. The hydraulic line according to claim 13, wherein EPM or EPDM are added to the polyamide molding compounds in quantities of 5 to 20% by weight as impact strength modifiers.

15. The hydraulic line according to claims 14, comprising:
an inner layer comprised of a molding compound based on polyamide molding compound filled with nano-scale fillers;
an interlayer comprised of polyolefin or a molding compound based on ethylene/vinyl alcohol copolymers; and
a polyamide outer layer.

16. The hydraulic line according to claim 15, wherein, as the polyamides for the inner and the outer layer are used chosen from the group comprising polymerizates of aliphatic C₆-C₁₂ lactams or (o-amino carboxylic acids with 4 to 44 carbon atoms, preferably 4 to 18 carbon atoms or copolymers, obtainable by polycondensation of at least one diamine of the group comprising the aliphatic diamines with 4 to 12 C-atoms, the cyclo-aliphatic diamines with 7 to 22 C-atoms and the aromatic diamines with 6 to 22 C-atoms in combination with at least one dicarboxylic acid from the group comprising aliphatic dicarboxylic acids with 4 to 12 C-atoms, cyclo-aliphatic dicarboxylic acid with 8 to 24 C-atoms and aromatic dicarboxylic acids with 8 to 20 C-atoms, and blends thereof.

17. The hydraulic line according to claim 16, wherein the polyolefin of the interlayer is selected from the group consisting of polypropylene, a mixture of ethylene/α-olefin co-polymer and ethylene/alkyl (meth)acrylate/maleic anhydride or glycidyl (meth)acrylate co-polymer.

18. The hydraulic line according to claim 16, wherein the polyamide of the inner layer is chosen from the group comprising polyamide 12, polyamide 6, polyamide 610, polyamide 612, the polyolefin of the interlayer comprising polypropylene and the outer layer comprising polyamide 12.

19. The hydraulic line according to claim 16, which comprises an inner layer comprised of a molding compound based on polyamide 6, polyamide 46, polyamide 66, polyamide 69, polyamide 610 or polyamide 12, and said layer comprised of a molding compound based on ethylene/vinyl alcohol co-polymers, if required, a bonding layer disposed therebetween and an outer layer of polyamide 12.

20. The hydraulic line according to claim 15, wherein it has at least in part a corrugated wall.

21. The hydraulic line according to claim 20, wherein it has been produced in one or a plurality of stages by a process selected from the group consisting of injection molding, co-extrusion, extrusion-blow-molding, pressing or sheating process.
